(19) United States
(12) Patent Application Publication
(10) Pub. No.: US 2004/0076392 A1
(43) Pub. Date: Apr. 22, 2004

(54) Low Kappa, dual-moat DC fiber and optical transmission line

(76) Inventors: Scott R. Bickham, Coring, NY (US); Gang Qi, Milford, CT (US); David K. Smith, Wilmington, NC (US); William A. Wood, Painted Post, NY (US)

Correspondence Address: CORNING INCORPORATED, SP-TI-3-1, CORNING, NY, 14831

(21) Appl. No.: 10/668,390

(22) Filed: Sep. 23, 2003

Related U.S. Application Data
(60) Provisional application No. 60/419,187, filed on Oct. 17, 2002.

(51) Int. Cl. G02B 6/22

(52) U.S. Cl. 385/127

(57) ABSTRACT

A optical fiber, for example a Dispersion Compensation (DC) fiber, for compensating dispersion of a transmission fiber (such as a NZDSF) and transmission line including same. The fiber has a refractive index profile having a first moat with a negative delta (Δ2), and a second moat with a negative delta (Δ4) wherein the fiber exhibits a negative total dispersion at 1550 nm, and kappa at 1550 nm of less than 75 nm. The DC fiber, when used in a transmission line, may provide low residual dispersion across the C band when such lines include transmission fibers with total dispersion between 2 and 6 ps/nm/km and dispersion slope less than 0.092 ps/nm²/km at 1550 nm.

### CROSS-REFERENCE TO RELATED APPLICATIONS

This application claims the benefit of priority under 35 U.S.C. §119(e) of U.S. Provisional Application Serial No. 60/419,187 filed on Oct. 17, 2002.

### BACKGROUND OF THE INVENTION

1. Field of the Invention

The present invention relates generally to optical fiber, and more particularly to dispersion compensation fiber and transmission lines including combinations of NZDSF transmission fiber and dispersion compensation fiber.

2. Technical Background

Higher data rates and wider bandwidth systems are becoming needed for the telecommunications industry. Thus, the search for high performance optical fibers designed for long distance, high bit rate telecommunications that operate over broad bandwidths has intensified. These high data rates and broad bandwidths, however, have penalties associated with them. In particular, dispersion is a significant problem in such systems. More specifically, positive dispersion builds along the length of the high data rate transmission fiber. Dispersion Compensating (DC) fibers included in cable or in Dispersion Compensation Modules (DCM's) have been designed that compensate for such dispersion. These fibers generally have negative total dispersion and dispersion slope around 1550 nm. For C-band operation between 1525 nm and 1565 nm, the bend performance (both macro-bending and micro-bending) and other properties, such as dispersion, dispersion slope and kappa of the DC fiber are important.

Thus, there is a need for a DC fiber which: (1) exhibits fairly linear properties over the C-band in a wavelength range (1525 nm to 1565 nm); (2) retains the usual high performance optical fiber characteristics such as high strength, low attenuation and acceptable resistance to micro- and macro-bend induced loss, and (3) is particularly effective at compensation for the dispersion of certain NZDSF transmission fibers across the C bands with low average residual dispersion.

### SUMMARY OF THE INVENTION

DEFINITIONS

The following definitions are used herein.

Refractive Index Profile—The refractive index profile is the relationship between refractive index and optical fiber radius (as measured from the fiber's centerline) for the DC fiber.

Segmented Core—A segmented core is one that has multiple segments in the physical core, such as a first and a second segment (a central core, a moat and a ring, for example). Each core segment has a respective refractive index profile and a maximum and minimum refractive index therein.

Radii—As shown in FIG. 3, the radii of the segments of the physical core are defined in terms of the beginning and end points of the segments of the refractive index profile of the fiber 20 with reference to the refractive index zero. FIG. 3 best illustrates the definitions of radii R1, R2, R3, R4 and R5 used herein. The same dimension conventions apply for defining the radii in the other refractive index profiles described herein in FIGS. 8-11. The radius R1 of the central core 22 extends from the DC fiber's centerline CL to the point at which the refractive index profile crosses the relative refractive index zero 23 as measured relative to the cladding 30. The outer radius R2 of the first moat segment 24 extends from the centerline CL to the radius point at which the outer edge of the moat crosses the refractive index zero 23, as measured relative to the cladding 30. Radius R3 is measured to the radius point at the approximate center of the ring 26. In particular, R3 is measured to the center point 27 of the half height dimension Wh. The half height dimension is the width Wh at the position Δ3/2, as measured relative to the cladding 30. Radius R4 is the radius point at which the inner edge of the second moat 28 crosses the refractive index zero 23, as measured relative to the cladding 30. Finally, R5 is the radius point at which the outer edge of the second moat 28 crosses the refractive index zero 23, as measured relative to the cladding 30.

Effective Area—The effective area is defined by the equation:

A_{eff}=2π(∫E²rdr)²/(∫E⁴rdr)

where the integration limits are 0 to ∞, r is the fiber radius, and E is the electric field associated with the propagated light as measured at 1550 nm.

Δ% or Delta (%)—The term, Δ% or Delta (%), represents a relative measure of refractive index and is defined by the equation:

Δ%=100(nᵢ²−n_{c}²)/2nᵢ²

where nᵢ is the maximum refractive index (highest positive or lowest negative) in the respective region i (e.g., 22, 24, 26, 28), unless otherwise specified, and n_{c} is the refractive index of the cladding (e.g., 30—which is preferably pure silica) unless otherwise specified.

α-profile—The term alpha profile, α-profile refers to a refractive index profile of the core 22, expressed in terms of Δ(b)%, where b is radius, which follows the equation,

Δ(b)%=Δ(b₀){1−[|b−bₒ|/(b₁−b₀)]^{α}}100

where bₒ is the maximum point of the profile of the core and b₁ is the point at which Δ(b)% is zero and b is in the range bᵢ≦b≦b_{f}, where Δ% is defined above, bᵢ is the initial point of the α-profile, b_{f} is the final point of the α-profile, and a is an exponent which is a real number. The initial and final points of the α-profile are selected and entered into the computer model. As used herein, if an α-profile is preceded by a step index profile, the beginning point of the α-profile is the intersection of the α-profile and the step profile. In the model, in order to bring about a smooth joining of the α-profile with the profile of the adjacent profile segment, the equation is rewritten as;

Δ(b)%=[Δ(bₐ)+[Δ(bₒ)−Δ(bₐ)]{(1−[|/(b₁−bₒ)]^{α}}]100,

where bₐ is the first point of the adjacent segment.

Pin array macro-bending test—This test is used to compare relative resistance of optical fibers to macro-bending. To perform this test, attenuation loss is measured when the optical fiber is arranged such that no induced bending loss occurs. This optical fiber is then woven about the pin array and attenuation again measured at 1550 nm. The loss induced by bending is the difference between the two attenuation measurements in dB. The pin array is a set of ten cylindrical pins arranged in a single row and held in a fixed vertical position on a flat surface. The pin spacing is 5 mm, center-to-center. The pin diameter is 0.67 mm. The optical fiber is caused to pass on opposite sides of adjacent pins. During testing, the optical fiber is placed under a tension sufficient to make the optical fiber conform to a portion of the periphery of the pins.

Lateral load test—Another bend test referenced herein is the lateral load test that provides a measure of the micro-bending resistance of the optical fiber. In this test, a prescribed length of optical fiber is placed between two flat plates. A #70 wire mesh is attached to one of the plates. A known length of optical fiber is sandwiched between the plates and the reference attenuation at 1550 nm is measured while the plates are pressed together with a force of 30 newtons. A 70 newton force is then applied to the plates and the increase in attenuation in dB/m is measured. This increase in attenuation is the lateral load attenuation of the optical fiber.

Trim fiber—As used herein trim fiber is any fiber that is used in conjunction with a transmission fiber and a dispersion compensating fiber to trim the dispersion and/or slope of a transmission line, and more particularly to reduce the residual dispersion of a transmission line over a particular operating window.

High-To-Low Residual Dispersion—High-to-low residual dispersion is a measure of the residual dispersion over a specified wavelength band, as measured from the highest residual dispersion to the lowest residual dispersion over the band. Residual dispersion is measured herein in ps/nm per 100 km of transmission fiber.

### SUMMARY

In accordance with embodiments of the present invention, a optical fiber, such as a Dispersion Compensating (DC) fiber, is provided having a refractive index profile with a first moat having a negative delta (Δ2), a second moat having a negative delta (Δ4), and the refractive index profile is selected to provide a negative total dispersion at 1550 nm, and a kappa value, defined as the total dispersion at 1550 nm divided by the dispersion slope at 1550 nm, of less than 75 nm.

In accordance with further embodiments of the present invention, the optical fiber preferably has a central core having a positive core delta (Δ1) and a ring surrounding the first moat having a positive ring delta (Δ3). Total dispersion for the fiber is preferably more negative than about −40 ps/nm/km at 1550 nm; more negative than about −140 ps/nm/km at 1550 nm in some embodiments; and is most preferably more negative than −40 and less negative than −400 ps/nm/km at 1550 nm. Dispersion slope of the fiber is preferably less than about −0.75 ps/nm²/km at 1550 nm; and more preferably less than −0.75 and greater than −8.50 ps/nm²/km at 1550 nm. The fiber's kappa is preferably between about 40 and 75 nm at 1550 nm.

The preferable fiber attributes may be achieved by providing the following structure. Delta (Δ1) of the central core is preferably less than 2.0% and the outer core radius (R1) of the central core is preferably between about 1.2 and 3.1 microns. The central core preferably has an alpha (C1) of less than about 6. The first moat preferably has a delta (Δ2) of less than −0.2%, and an outer radius (R2) of the first moat between about 4.5 and 10.6 microns. A ring is preferably positioned between the first moat and the second moat, and preferably includes a delta (Δ3) greater than about 0.2%, and a radius (R3) to an approximate center of the ring between about 6.5 and 12.0 microns. The second moat delta (Δ3) is preferably less than −0.05%, and has an outer radius (R5) between about 19.5 and 37.5 microns.

According to further embodiments of the invention, an optical transmission line is provided wherein the fiber is a dispersion compensating fiber as set forth above optically connected to a transmission fiber having a total dispersion between about 2 and 6 ps/nm/km at 1550 nm, and a positive dispersion slope of less than 0.092 ps/nm²/km at 1550 nm. Additionally, the dispersion compensating fiber may be optically coupled to a trim fiber which has a total dispersion between about 14 and 21 ps/nm/km at 1550 nm, and a positive dispersion slope of between about 0.04 and 0.07 ps/nm²/km at 1550 nm. Residual dispersion of the transmission lines are preferably less than 50 ps/nm per 100 km of transmission fiber; and less than 30 ps/nm per 100 km of transmission fiber for some embodiments.

The DC fiber according to the invention has the advantage of having improved resistance to macro-bending (improved pin array) as compared to single moat designs. Furthermore, the dual moat design described herein may also enables lower cut-off wavelength as compared to single moat designs.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operations of the invention.

### BRIEF DESCRIPTION OF THE DRAWINGS

FIG. 1 is a block depiction of a transmission line including a dual-moat DC fiber in accordance with the present invention.

FIG. 2 is a representative cross-sectional end view of embodiments of the DC fiber in accordance with the present invention.

FIG. 3 is a graphic plot of a refractive index profile for a first embodiment of DC fiber in accordance with the present invention.

FIGS. 4-6 are graphic plots of attributes (dispersion slope, total dispersion and kappa) for the DC fiber of FIG. 3.

FIG. 7 is a graphic plot of residual dispersion per 100 km of transmission fiber vs. wavelength for a transmission line including a DC fiber of FIG. 3 in accordance with the present invention.

FIGS. 8-11 are graphic plots of refractive index profiles for other embodiments of DC fiber in accordance with the present invention.

FIGS. 12-14 are graphic plots of dispersion slope, total dispersion and kappa, respectively, as a function of wavelength for the DC fibers of FIGS. 8-11.

FIG. 15 is a graphic plot of residual dispersion per 100 km of transmission fiber vs. wavelength for a transmission line including a DC fiber of FIGS. 3 and 8-11.

FIG. 16 is a graphic plot of a transmission line including the inventive DC fiber and a trim fiber in accordance with another embodiment of the present invention.

FIG. 17 is a graphic plot of a refractive index profile of a representative NZDSF transmission fiber used in the transmission line of FIGS. 1 and 16 in accordance with the present invention.

FIG. 18 is a graphic plot of the attributes (total dispersion and dispersion slope) of the representative transmission fiber of FIG. 17 in accordance with the present invention.

### DETAILED DESCRIPTION OF THE PREFERRED EMBODIMENTS

Reference will now be made in detail to the present preferred embodiment(s) of the invention, examples of which is/are illustrated in the accompanying drawings. Whenever possible, the same reference numerals will be used throughout the drawings to refer to the same or like parts.

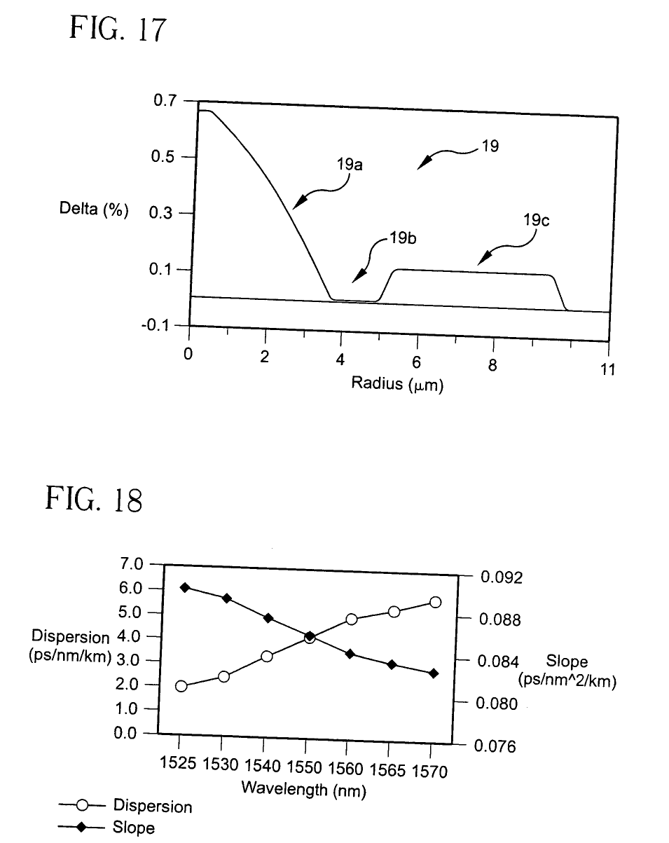

By way of example, and not to be considered limiting, an optical transmission line 18 of, for example, a DWDM system is illustrated in FIG. 1 having a length of about 100 km of a transmission fiber 19, such as a Non-Zero Dispersion Shifted Fiber (NZDSF), optically coupled to a DC fiber 20 in accordance with embodiments of the invention described herein. One preferred transmission fiber 19 in the transmission line 18 is Corning® LEAF® optical fiber, as is shown and described with reference to FIGS. 17 and 18 herein. The transmission fiber 19 has a positive total dispersion between about 2 and 6 ps/nm/km at a wavelength of about 1550 nm, and a positive dispersion slope less than about 0.092 ps/nm²/km at 1550 nm as is shown in FIG. 18. Kappa of the NZDSF transmission fiber 19 is preferably between about 40 and 70 nm at 1550 nm. Kappa is defined herein as the total dispersion of the optical fiber at 1550 nm divided by the dispersion slope at 1550 nm.

In transmission line 18, the DC fiber 20 compensates for built up dispersion resulting from passing a light signal through the transmission fiber 19 (as indicated by arrow 41). It should be recognized that although the system 18 is described herein as being unidirectional, that transmission lines including the DC fiber 20 described herein may have signals passing in both directions.

In representative transmission lines 18, built up dispersion of the transmission fiber 19 (e.g., a NZDSF) is compensated for by a preferably shorter length of DC fiber 20, having a length of between about 1.0 and 5.0 km in accordance with the invention. The transmission line 18 may include an amplifier 42 (which may include a pre-amp and power amp) or any other conventional amplifier arrangement. The line 18 may also include other conventional components such as a transmitter 40 and receiver 46. Optionally, the transmission line 18 may couple to one or more additional lengths of NZDSF or other transmission fiber instead of terminating at the receiver 46. Further additional components such as filters, couplers, and amplifiers may also be included in the transmission line.

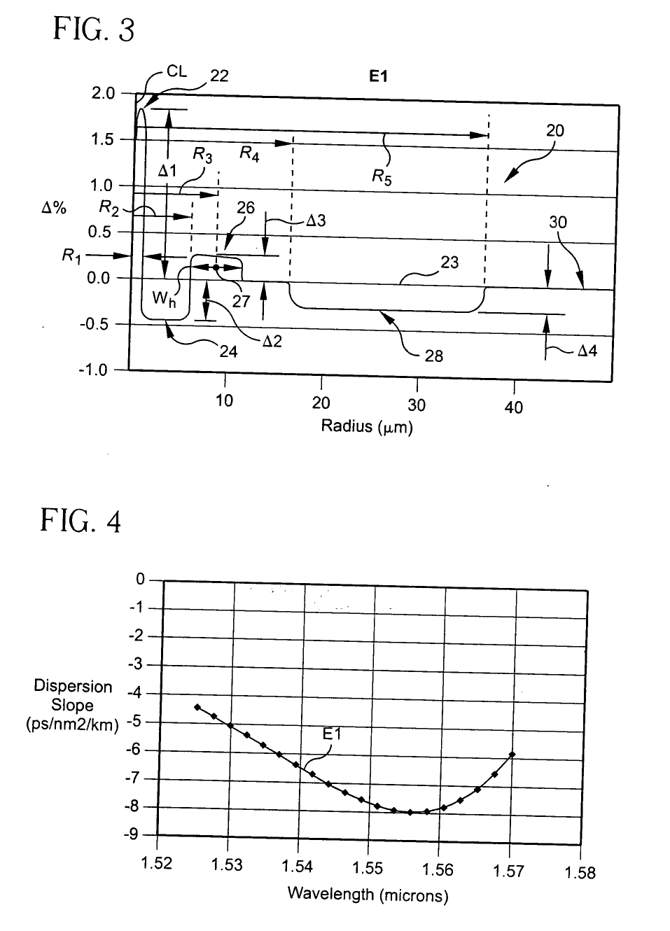

The family of DC fibers 20 according to the invention have segmented core structures. A first embodiment of the fiber 20 is illustrated in FIG. 3 and includes, preferably, a central core 22 having a positive delta (Δ1), a first moat 24 having a negative delta (Δ2), a ring 26 having a positive delta (Δ3), and a second moat 28 having a negative delta (Δ4); all deltas (Δ1-Δ4) being measured relative to the cladding 30.

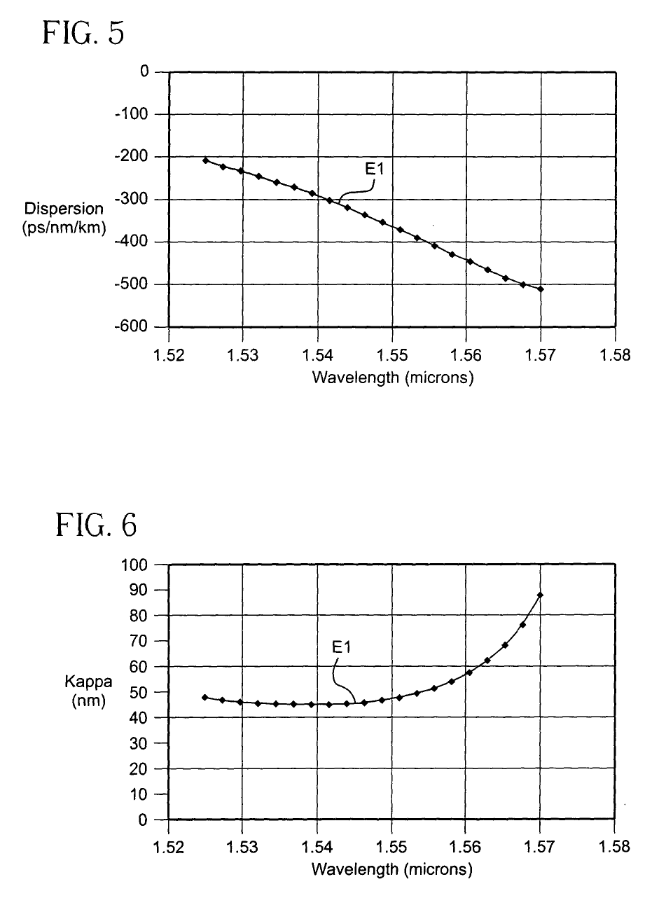

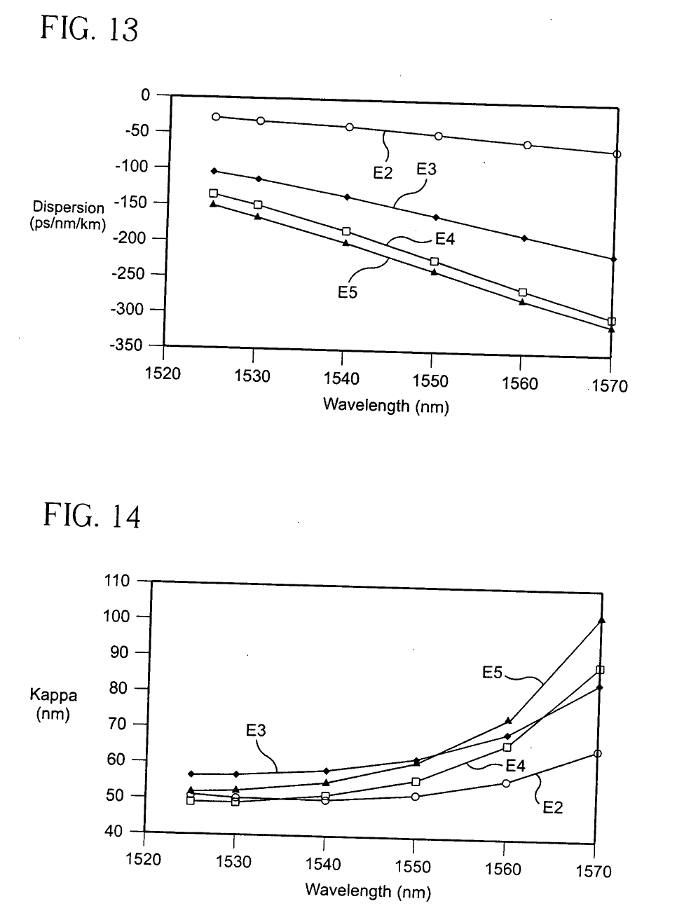

The family of DC fibers 20 shown and described herein with reference to FIGS. 3-6 and 8-14 all include refractive index profiles with a physical core having a central core 22 with a positive maximum core delta (Δ1) of less than 2.0% (measured to the highest point in the central core), a first moat 24 surrounding the central core 22 having a negative minimum moat delta (Δ2) more negative than 0.2% (measured to the lowest point in the first moat), a ring 26 surrounding the first moat having a positive ring delta (Δ3) which is preferably greater than 0.2% (measured to the highest point on the ring), and a second moat 28 having a negative moat delta (Δ4) which is preferably more negative than −0.05% (measured to the lowest point in the second moat).

The refractive index profile of the DC fibers 20 is selected to provide a total dispersion more negative than 40 ps/nm/km at 1550 nm, more negative that −140 ps/nm/km at 1550 nm for some embodiments, and more preferably between about 40 and −400 ps/nm/km at 1550 nm. The dispersion slope of the family of fibers is preferably less than 0.75 ps/nm²/km at 1550 nm, and more preferably between about −0.75 and −8.50 ps/nm²/km at 1550 nm; and a kappa, defined as the total dispersion at 1550 nm divided by the dispersion slope at 1550 nm, of less than 75 nm, and more preferably between 75 and 40 nm at 1550 nm. Total dispersion, dispersion slope and kappa plots for the various embodiments of DC fiber 20 in accordance with the invention are illustrated in FIGS. 4-6 and 12-14.

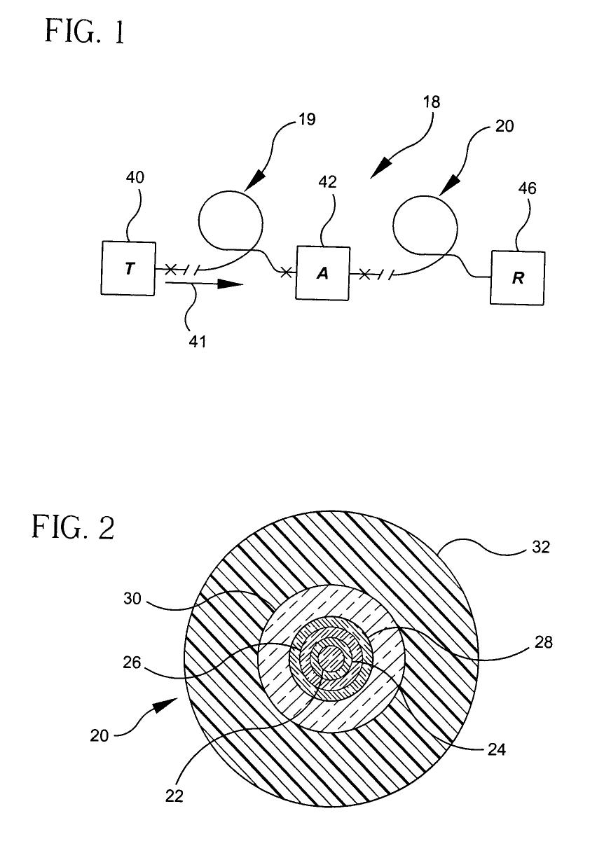

The core 22 preferably includes an α-profile, where α is less than about 6, and more preferably may vary between about 0.08 and 6. The DC fibers 20 preferably also include a cladding 30 surrounding the physical core that is preferably pure silica. The cladding 30 of the DC fibers 20 is preferably surrounded by a conventional UV-curable polymer coating 32 (see FIG. 2), such as a urethane acrylate coating. Preferably, the coating 32 exhibits a low-modulus primary coating, and a high-modulus outer secondary coating, as is known to those of ordinary skill in the art.

The DC fibers 20 each have a refractive index profile including a physical core surrounded by a cladding 28 which extends to the outermost glass periphery of the fiber. The DC fibers 20 in accordance with another feature of the invention exhibit an effective area that is between about 16 and 30 square microns at 1550 nm; and most preferably greater than 17.5 square microns, while the pin array bend loss at 1550 nm remains less than about 9 dB.

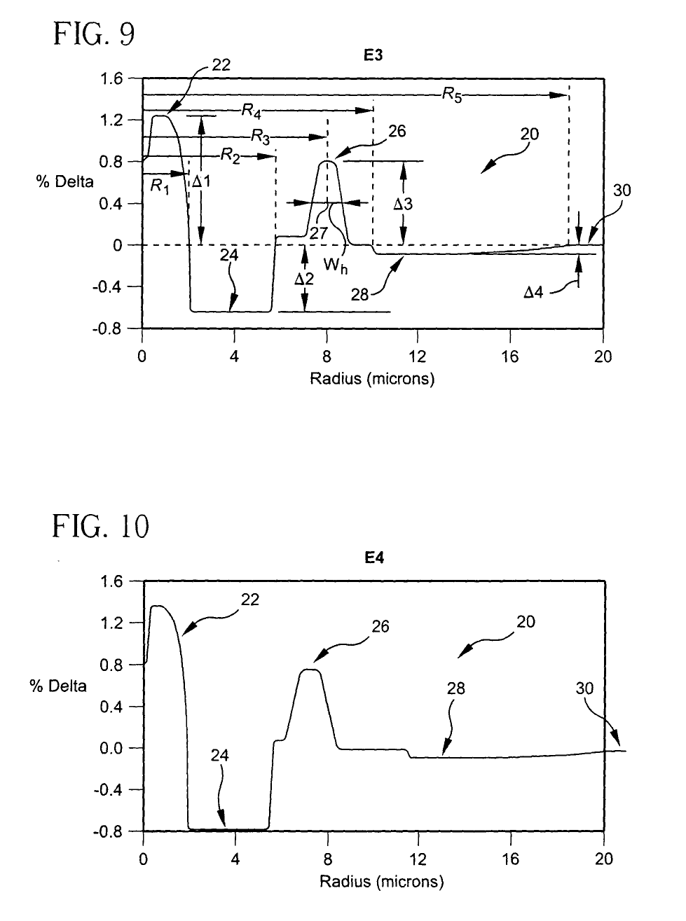

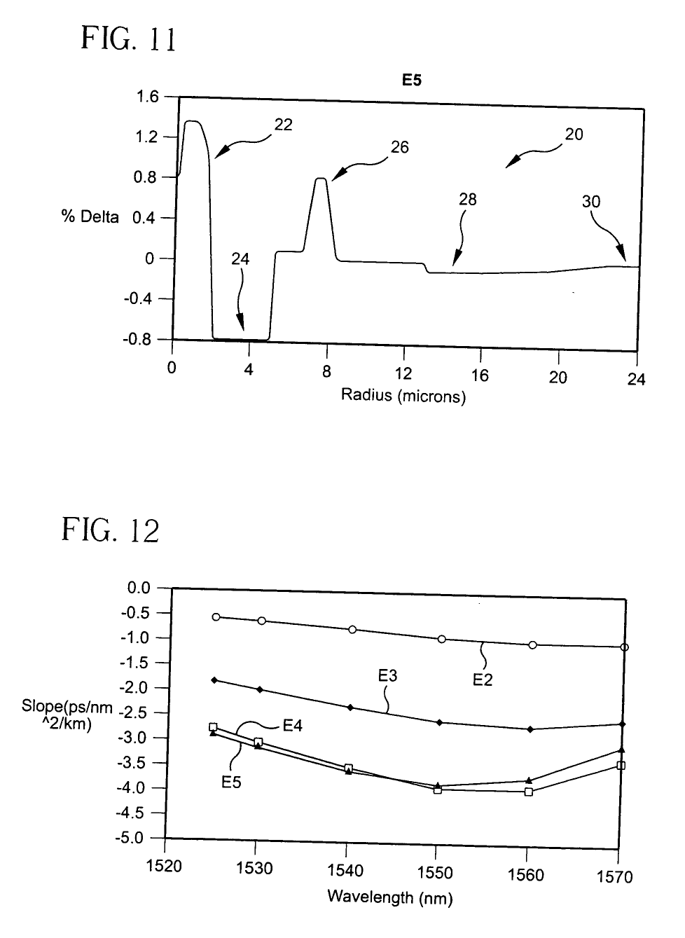

The general structure of the family of DC fibers 20 in accordance with the invention are best shown in FIGS. 3 and 8-11 and are listed in Table 1 below as examples 1-5. FIGS. 3, 8 and 9 illustrate the radii dimensions R1, R2, R3, R4 and R5 the delta parameters Δ1, Δ2, and Δ3, Δ4, and the ring half width Wh (the width measured at half the ring delta Δ3/2). In particular, the conventions utilized to measure these parameters for FIG. 9 are also applicable to the refractive index profiles of FIGS. 10-11.

In accordance with further preferred structure of the invention, the refractive index profile of the family of DC fibers 20 preferably includes a central core 22 having a radius (R1) of between about 1.2 and 3.1 microns; a first moat radius (R2) of between about 4.5 to 10.6 microns; a ring radius (R3) to the approximate center of the ring of between about 6.5 and 12.0 microns; an second moat inner radius (R4) of between about 10.0 and 17.5 microns; and a second moat outer radius (R5) of between about 19.5 and 37.5 microns. The ring 26 preferably has a ring half width (Wh) which is preferably between about 1.0 to 5.3 microns. The ring 26 may be offset from the outer edge of the first moat 24 by a defined ring offset Ro as shown in the embodiments of FIGS. 9-11. The ring offset Ro is determined as follows:

Ro=[R3−R2]−Wh/2.

Ro is preferably between about 0.7 and 1.8 microns.

By way of further clarification on utility, the DC fiber may be used in a transmission line 18 (see FIGS. 1 and 16) having a first section of positive dispersion, positive dispersion slope transmission fiber 19, such as the NZDSF described above, and a DC fiber 20 in accordance with the embodiments of the invention described herein having a negative total dispersion and a negative dispersion slope at 1550 nm. The transmission lines 18 described herein illustrate very low residual dispersions across the C-bands for a representative length of 100 km of transmission fiber 19.

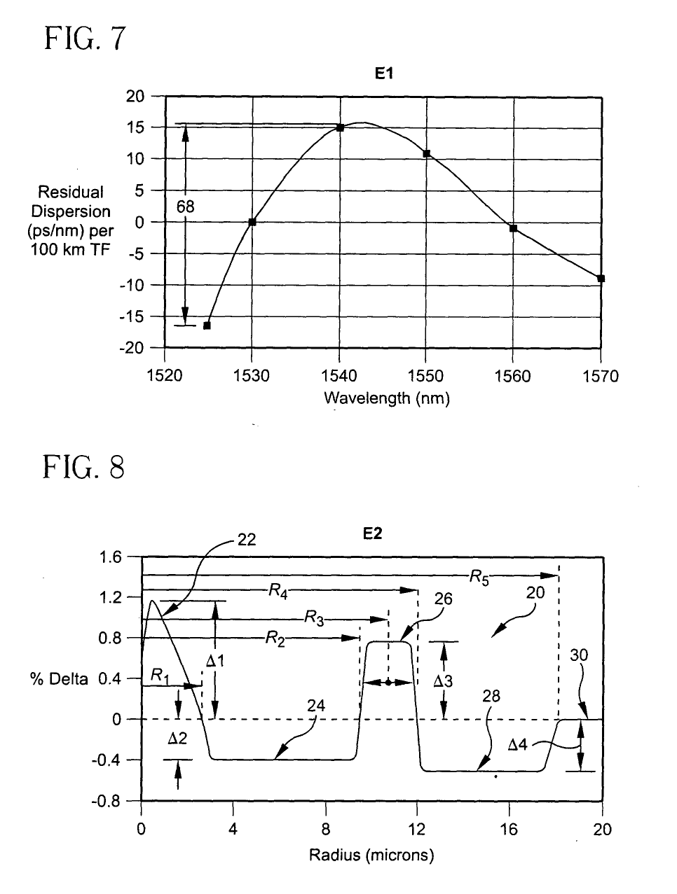

FIG. 7 illustrates residual dispersion of a transmission line 18 including a 1.14 km length of DC fiber 20 described in detail with respect to FIGS. 3-6, and a span of 100 km of transmission fiber (TF) described in Table 2 below. It should be recognized that the DC fiber 20 in accordance with embodiments of the invention may be housed in the form of a conventional Dispersion Compensating Module (DCM), for example. The FIG. 7 plot illustrates a plot of residual dispersion per 100 km of transmssion fiber vs. wavelength. Illustrated is a high-to-low residual dispersion 68 over the C-band (1525 to 1565 run) of less than about 50 ps/nm; more preferably less than about 40 ps/nm per 100 km of transmission fiber 18.

### EXAMPLES

The present invention will be further clarified by the following examples that are summarized in Table 1 below. Table 1 includes attributes (such as Total Dispersion at 1550 nm, Dispersion Slope at 1550 nm, Kappa at 1550 nm, Pin Array at 1550 nm, Lateral Load at 1550 nm, Effective Area at 1550 nm and theoretical cutoff wavelength) and refractive index structural parameters (Δ1-Δ4, α1, R1-R5, Ro and Wh) for the DC fibers 20 in accordance with the refractive index profiles corresponding to FIGS. 3 and 8-11 and attribute plots corresponding to FIGS. 4-6 and 12-14. Legends are included on each plot for identification of the examples.

TABLE 1
Dispersion Compensation Fiber Examples

| | Disp. | Slope | Kappa | | | | | | |
|---|---|---|---|---|---|---|---|---|---|
| | (ps/nm/km) @ | (ps/nm²/km) @ | (nm) @ | | | | | Ro | |
| Ex. | 1550 nm | 1550 nm | 1550 nm | Δ1% | α1 | Δ2% | Δ3% | μm | Δ4% |
| E1 | −363 | −7.67 | 47 | 1.84 | 2.0 | −0.44 | 0.26 | 0.0 | −0.30 |
| E2 | −45 | −0.86 | 52 | 1.35 | 1.0 | −0.39 | 0.77 | 0.0 | −0.51 |
| E3 | −158 | −2.53 | 63 | 1.25 | 5.2 | −0.65 | 0.80 | 1.6 | −0.09 |
| E4 | −219 | −3.88 | 57 | 1.37 | 4.8 | −0.78 | 0.75 | 0.8 | −0.08 |
| E5 | −235 | −3.80 | 62 | 1.35 | 5.6 | −0.79 | 0.81 | 1.4 | −0.09 |

| | | | | | | | Pin | Lat. | | |
|---|---|---|---|---|---|---|---|---|---|---|
| | | | | | | | Array @ | Load @ | | |
| | R1 | R2 | R3 | R4 | R5 | Wh | 1550 nm | 1550 nm | Aeff | λc^{th} |
| Ex. | (μm) | (μm) | (μm) | (μm) | (μm) | (μm) | (dB) | (dB/m) | (μm²) | (nm) |
| E1 | 1.33 | 5.99 | 8.50 | 15.82 | 34.15 | 4.76 | 7.93 | 0.25 | 18.3 | 1652 |
| E2 | 2.81 | 9.65 | 10.78 | 12.00 | 17.80 | 2.23 | 3.61 | 1.10 | 27.6 | 1878 |
| E3 | 1.98 | 5.61 | 7.90 | 9.92 | 18.50 | 1.30 | 6.73 | 2.15 | 20.9 | 1729 |
| E4 | 1.92 | 5.55 | 7.19 | 11.56 | 20.80 | 1.58 | 5.51 | 2.04 | 19.9 | 1715 |
| E5 | 1.89 | 5.08 | 7.39 | 12.98 | 22.22 | 1.21 | 7.33 | 2.85 | 20.4 | 1703 |

TABLE 2
NZDSF transmission fiber data

| | |
|---|---|
| Attribute | Value |

| | |
|---|---|
| Total Dispersion (ps/nm/km) @ 1550 nm | 4.2 |
| Slope (ps/nm²/km) @ 1550 nm | 0.085 |
| Lambda Zero (nm) | 1500 |
| Kappa (nm) @ 1550 nm | 49.4 |

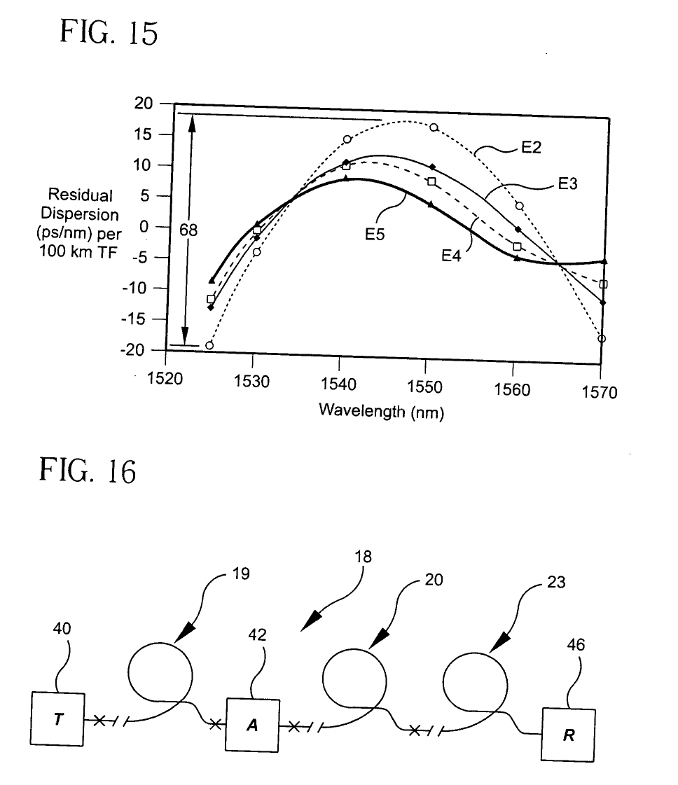

FIG. 15 illustrates plots of modeled residual dispersion over the C-band (1525 to 1565 nm) for a transmission line 18 including various lengths of the DCF 20 and trim fiber 23 as described in Table 3 below. The transmission fiber 19 used in the model has a length of 100 km and is a NZDSF whose refractive index profile is shown in FIG. 17, and whose dispersion, dispersion slope, kappa and lambda zero are further described in FIG. 18 and Table 2.

As shown in FIG. 17, the preferred transmission fiber 19 is a NZDSF and includes a central core 19a, an annular moat region 19b, and a ring 19c. The core 19a, moat 19b, and the ring 19c are preferably germanium doped and have positive deltas relative to the cladding 12. Further description of this transmission fiber may be found in U.S. Pat. No. 6,212,322 entitled “Positive Dispersion Low Dispersion Slope Fiber,” the disclosure of which is hereby incorporated by reference herein. As illustrated in FIG. 15, the modeled High-to-Low residual dispersion 68 (E2 shown is the worst case) for the transmission line 18 in the C-band (1525 to 1565 nm) is less than about 50 ps/nm (per 100 km of transmission fiber) for all the profiles when trimmed with a section of trim fiber 23 as is described with reference to FIG. 16. Many of the profiles exhibit modeled High-to-Low residual dispersion for the transmission line 18 in the C-band (1525 to 1565 nm) of less than about 30 ps/nm per 100 km of transmission fiber.

As is best illustrated in FIG. 16, the transmission lines 18 may be made up of optically- and serially-coupled lengths of transmission fiber 19, DC fiber 20 and trim fiber 23. The transmission fiber 19 is preferably a NZDSF and preferably has a total dispersion ranging from about 2 to 6 ps/nm/km at 1550 nm; and most preferably about 4.2 ps/nm/km. A dispersion slope of the transmission fiber 19 is preferably less than 0.092 ps/nm²/km at 1550 nm; and is most preferably about 0.085 ps/nm²/km at 1550 nm. Kappa for the transmission fiber 19 is preferably between about 40 and 75 nm at 1550 nm, and a zero dispersion wavelength (λ₀) of about 1500 nm. The DC fibers 20 may be any of the examples E2-E5 as described herein. The trim fiber 23 is preferably a step index single mode fiber, such as SMF-28® manufactured by Coming Incorporated of Corning, N.Y., having a total dispersion at 1550 nm of between about 14 and 21 ps/nm/km, more preferably about 17 ps/nm/km; a dispersion slope at 1550 nm of between about 0.04 and 0.07 ps/nm²/km, most preferably about 0.056 ps/nm²/km; a kappa of between about 245 and 365 nm at 1550 nm, most preferably about 303 nm; a zero dispersion wavelength (4) between about 1301.5 and 1321.5 nm; and a mode field diameter between about 9.6 and 12.2 microns. The transmission system 18 may include any of the aforementioned system components, such as amplifier 42, transmitter 40, receiver 46 and any other conventional components. The respective lengths of the transmission fibers 19, DC fibers 20, and trim fibers 23 in each example transmission line 18 are shown in Table 3.

TABLE 3
Examples of transmission lines.

| | | | | | High-to- | |
|---|---|---|---|---|---|---|
| | | | | | Low | |
| | | | | | Residual | |
| | | | Length | Length | Dispersion | |
| | | Length | DC | Trim | (ps/nm) | |
| Transmission | DC | TF | Fiber | Fiber | Per 100 km | |
| Line | Fiber | (km) | (km) | (km) | TF | Figure |
| 1 | E1 | 100 | 1.14 | 0.00 | 24.4 | |
| 2 | E2 | 100 | 1.29 | 3.22 | 22.7 | |
| 3 | E3 | 100 | 3.85 | 11.6 | 17.3 | |
| 4 | E4 | 100 | 2.48 | 7.7 | 45.4 | |
| 5 | E5 | 100 | 2.59 | 11.1 | 31.5 | |

The DC fibers 20 in accordance with them present invention may be drawn from optical fiber preforms utilizing conventional draw methods and apparatus. The optical fiber preform from which the present invention DC fibers 20 are drawn may be manufactured in accordance with any known method, such as any known chemical vapor deposition method. Chemical vapor deposition methods include OVD, MCVD, PCVD or the like. Most preferably, the DC fiber preform may be manufactured by an OVD method wherein the preform portion corresponding to the central core 22 is first manufactured by depositing silicon oxide soot doped with germania oxide onto a rotating tapered alumina mandrel to a desired diameter. The soot is doped with the appropriate level of germania dopant to achieve the desired refractive index profile for the central core segment including the appropriate Al. The mandrel is then removed and the soot preform constituting the central core 22 is thoroughly dried in a preferably helium- and chlorine-containing environment and then consolidated in a consolidating furnace including a helium atmosphere. The consolidated central core blank is then redrawn into a single-segment core cane of suitable diameter. During the redraw process, the centerline aperture resulting from removal of the mandrel is closed through the application of a vacuum or by other known methods.

Redrawn single-segment core cane then becomes the target deposition surface for the application of further soot to form the preform portion corresponding to the first moat 24. Silica soot is deposited onto the cane to an appropriate diameter for the first moat and is then preferably dried within a consolidation furnace within a helium- and chlorine-containing atmosphere in a consolidation furnace. The soot preform is then doped with a suitable fluorine-containing gas, such as C₂F₆, C₂F₂Cl₂, CF₄, SF₆, or SiF₄, or the like, and subsequently consolidated and again redrawn into a two-segment core cane. U.S. Pat. No. 4,629,485 to Berkey describes one such suitable method for fluorine doping an optical fiber preform.

This two-segment core cane material now becomes the deposition surface for the preform portion corresponding to the ring 26. Germania-doped silica soot is next deposited on the two-segment cane and is subsequently dried and consolidated as herein before described. Again, the consolidated blank is redrawn and this time becomes the three-segment core cane including three segments corresponding to the central core 22, first moat 24, and ring 26 of the segmented physical core. Additional soot is deposited onto the three-segment core cane to the desired diameter, dried, doped and consolidated similarly to the first moat to provide the desired Δ4. This perform is than redrawn to form the final core case. Additional silica soot that comprises the cladding 30 is then deposited on the final core cane to form the overclad soot blank. The overclad soot blank is dried and consolidated and subsequently transferred to a draw furnace where the present invention DC fiber 20 is drawn therefrom in accordance with conventional draw methods.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. An optical fiber, comprising:
a refractive index profile having
a first moat with a negative delta (Δ2),
a second moat with a negative delta (Δ4), and
the refractive index profile is selected to provide
a negative total dispersion at 1550 nm,
a kappa value, defined as total dispersion divided by dispersion slope at 1550 nm, of less than 75 nm.

2. The fiber of claim 1 further comprising
a central core having a positive delta (Δ1), and
a ring surrounding the first moat having a positive delta (Δ3).

3. The fiber of claim 1 wherein the total dispersion at 1550 nm is more negative than about −40 ps/nm/km.

4. The fiber of claim 1 wherein the total dispersion at 1550 nm is more negative than −40 and less negative than −400 ps/nm/km.

5. The fiber of claim 1 wherein the total dispersion at 1550 nm is more negative than about −140 ps/nm/km.

6. The fiber of claim 1 wherein the dispersion slope at 1550 nm is less than −0.75 and greater than −8.50 ps/nm²/km.

7. The fiber of claim 1 wherein kappa at 1550 nm is between about 40 and 75 nm.

8. The fiber of claim 1 including a pin array bend loss at 1550 nm of less than 9 dB.

9. The fiber of claim 1 wherein a central core has a delta (Δ1) of less than 2.0%.

10. The fiber of claim 9 wherein an outer core radius (R1) of the central core is between about 1.2 and 3.1 microns.

11. The fiber of claim 9 wherein the central core has an alpha (a) of less than about 6.

12. The fiber of claim 1 wherein delta (Δ2) of the first moat is less than −0.2%.

13. The fiber of claim 12 wherein an outer radius (R2) of the first moat is located between about 4.5 and 10.6 microns.

14. The fiber of claim 1 wherein delta (Δ4) of the second moat is less than −0.05%.

15. The fiber of claim 14 wherein an outer radius (R5) of the second moat is between about 19.5 and 37.5 microns.

16. An optical transmission line, wherein the fiber as set forth in claim 1 is a dispersion compensating fiber optically coupled to a transmission fiber, the transmission fiber having:
a total dispersion between 2 and 6 ps/nm/km at 1550 nm, and
a positive dispersion slope of less than 0.092 ps/nm²/km at 1550 nm.

17. The line of claim 16 wherein the transmission fiber comprises a kappa value, defined as total dispersion at 1550 nm divided by dispersion slope at 1550 nm, of between 40 and 75 nm.

18. The line of claim 16 wherein a High-to-Low residual dispersion for the transmission line over an entire C band having a wavelength range from 1525 nm to 1565 nm is less than 50 ps/nm for a 100 km length of transmission fiber.

19. The line of claim 16 wherein the dispersion compensating fiber is optically coupled to a trim fiber which has:
a total dispersion between 14 and 21 ps/nm/km at 1550 nm, and
a positive dispersion slope of between 0.04 and 0.07 ps/nm²/km at 1550 nm.

20. A dispersion compensation fiber, comprising:
a refractive index profile including
a central core having a positive core delta (Δ1) less than 2.0% and an outer radius (R1) between 1.2 and 3.1 microns,
a first moat having a moat delta (Δ2) more negative than −0.2% and an outer radius (R2) of between 4.5 and 10.6 microns,
a ring having a positive ring delta (Δ3) greater than 0.2% and a center radius (R3) of between 6.5 and 12.0 microns, and
a second moat having a delta (Δ4) less than −0.05% and an outer radius (R5) between 19.5 and 37.5 microns;
the refractive index profile selected to provide
a total dispersion less than −40 and greater than −400 ps/nm/km at 1550 nm;
a dispersion slope of between −0.75 and −8.5 ps/nm²/km at 1550 nm; and
kappa, defined as total dispersion at 1550 nm divided by dispersion slope at 1550 nm, of greater than 40 and less than 75 nm.
